(19) United States
(12) Patent Application Publication
(10) Pub. No.: US 2016/0200381 A1
(43) Pub. Date: Jul. 14, 2016

(54) Ergonomically Adjustable Motorcycle Seat Assembly

(71) Applicant: Milsco Manufacturing Company, A Unit of Jason Incorporated, Milwaukee, WI (US)

(72) Inventors: Jessica L. Lorbiecki, Sussex, WI (US); Adam J. Shileny, West Bend, WI (US)

(21) Appl. No.: 14/991,908

(22) Filed: Jan. 8, 2016

Related U.S. Application Data
(60) Provisional application No. 62/100,903, filed on Jan. 8, 2015.

(51) Int. Cl. B62J 1/00; B62J 1/14

(52) U.S. Cl. CPC B62J 1/00; B62J 1/14

(57) ABSTRACT

An ergonomic position adjustable vehicle seat assembly for motorcycle use having a position-adjustable driver or operator seat and which can be configured with a passenger seat, e.g., pillion, which also is position adjustable. The driver seat has a base with spaced apart position setting mounts configured for engagement with the motorcycle in mounting the seat thereto in a desired one of at least a plurality, preferably a plurality of pairs, of fore-aft spaced apart positions. A seat mounting bracket preferably is used to anchor the rear of the driver seat to the motorcycle once the desired seat position is set with such a bracket preferably further configured to enable position-adjustable attachment of the passenger seat thereto. Such a mounting bracket preferably is configured with at least a plurality of passenger seat position settings enabling the position of the passenger seat to be adjusted relative to the driver seat.

### CROSS REFERENCE

This application claims priority in U.S. Provisional Patent Application No. 62/100,903, filed Jan. 8, 2015, under 35 U.S.C. §119(e), the entirety of which is hereby expressly incorporated herein by reference.

### FIELD

The present invention is directed to a motorcycle seat assembly and more particularly to an adjustable motorcycle seat assembly with a mounting arrangement configured to provide ergonomic adjustment of seat position.

### BACKGROUND

Motorcycle riders come in all shapes and sizes but motorcycle seats typically are fixed in place offering virtually no adjustability. As a result of motorcycle seats not being very adjustable, if at all, most motorcycles have seats designed to try to fit as many different people as possible but which are not designed to fit the tallest and shortest riders. Even such attempts to try to design motorcycle seats to fit as many people as possible have fallen far short as many riders having a height or size falling within the intended fit range find the seating less than desirable. What ends up happening as a result is that prospective motorcycle purchasers' end up trying a wide variety of motorcycles having different types, sizes and shapes in an attempt to find a motorcycle that fits the rider. Even then, for those that are smaller, shorter, taller and heavier, it can be an exercise in futility often ending up buying a motorcycle with seating that is not very comfortable though more comfortable than anything else they evaluated.

What is needed is a motorcycle seat assembly and mounting arrangement that permits seat adjustment sufficient to fit the motorcycle to the rider instead of the other way around.

### SUMMARY

The present invention is directed to an ergonomic position-adjustable vehicle seat assembly particularly well suited for use in vehicles having fore-aft operator and passenger seating that is constructed and arranged to enable seat position adjustment of one or both of the operator seating and passenger seating to increase seat occupant comfort as well as provide enhanced operator ergonomics. A preferred ergonomic position-adjustable vehicle seat assembly is configured for use with motorcycles and constructed and arranged to enable at least an operator seat or driver seat to be position-adjustable in one of at least a plurality, preferably at least a plurality of pairs, i.e. at least three, of seat positions enabling the distance an operator or driver is positioned from the steering arrangement, preferably handlebars, of the motorcycle to be adjusted by changing operator or driver seat position thereby advantageously improving operator or driver ergonomics by making it more comfortable for an operator or driver to reach, grasp and use the handlebars. Where also equipped with a passenger seat, such as a pillion, disposed behind the operator or driver seat, such an ergonomic position-adjustable motorcycle seat assembly preferably is further constructed and arranged to enable passenger or rider seat position adjustment substantially in unison with operator or driver seat position adjustment such that both seats move together during seat position adjustment. A particularly preferred embodiment of such a position-adjustable motorcycle seat assembly equipped with a passenger seat, e.g., pillion, is constructed and arranged such that the position of the passenger seat can be changed independently of changing the position of the driver or operator seat thereby producing a position-adjustable motorcycle seat assembly of the present invention that not only provides improved driver or operator ergonomics and comfort but which also advantageously provides improved passenger or rider ergonomics and comfort.

In a preferred embodiment, at least one vehicle seat of the position-adjustable seat assembly is an operator or driver seat of a motorcycle that is configured to be mounted to part of the motorcycle, preferably part of its frame, in one of at least a plurality, preferably at least a plurality of pairs, i.e. at least three, of spaced apart seat positions which enable an operator or driver sitting in the seat to be positioned closer to the steering arrangement, preferably handlebars, and operator controls of the motorcycle when set in one seat position and farther away therefrom when set in another seat position. In one preferred position-adjustable motorcycle driver or operator seat, the seat includes a seat base having at least a plurality, preferably at least a plurality of pairs, i.e. at least three, fore-aft spaced apart seat position setting mounts configured such that the particular one of the mounts that engages the motorcycle in mounting the seat thereto determines or sets seat position. In one such preferred embodiment, each one of the seat position setting mounts includes a coupler configured to facilitate engagement with a portion of the motorcycle frame in mounting the seat thereto in the desired seat position associated with the particular coupler engaged therewith. In still another such preferred embodiment, each coupler can and preferably does include a receptacle defining a coupler socket configured to slidably and/or telescopically receive an outwardly projecting seat mounting tongue of a seat mounting bracket of an underlying seat-supporting portion of the motorcycle frame.

In such a preferred position-adjustable motorcycle operator or driver seat embodiment, a seat anchor preferably also is used in mounting the seat to the motorcycle after seat position adjustment. A preferred seat anchor preferably is a seat mounting bracket that includes at least a plurality, preferably at least a plurality of pairs, i.e. at least three, spaced apart fore-aft operator or driver seat position adjustment settings that enables the mounting bracket to be attached to the driver or operator seat using the seat position setting corresponding to the actual position that the seat is being mounted to the motorcycle. In a preferred embodiment, the position adjustment settings are provided by a plurality, preferably a plurality of pairs, i.e. at least three, of fore-aft spaced apart seat position defining mounting bores formed in the bracket each configured to accommodate a coupler, preferably a fastener, e.g. threaded bolt or stud, used to attach the bracket to the driver or operator seat base and help mount the seat to the motorcycle.

The seat mounting bracket preferably also includes a mounting portion extending rearwardly of the driver or operator seat that is configured not only to anchor or ground the rear of the driver or operator seat to the motorcycle but also to serve as a connector bridge between the driver or operator seat and a passenger seat, e.g. pillion, where the position-adjustable seat assembly is so equipped. In a preferred embodiment, the rearwardly extending mounting portion is a soleplate generally transversely extending between a pair of spaced apart and generally parallel fore-aft extending seat position adjuster arms defining a generally horseshoe-shaped or generally U-shaped seat anchor with each adjuster arm configured with one of a plurality, preferably plurality of pairs, i.e. at least three, driver or operator seat position settings each of which is preferably formed or defined by a corresponding seat position defining mounting bore. In such a preferred mounting bracket embodiment, the soleplate preferably also is equipped with at least a plurality, preferably a plurality of pairs, i.e. at least three, of fore-aft spaced apart passenger seat position determining mounting bores that enable the passenger seat, e.g. pillion, to be mounted thereto using one or more fasteners, e.g. threaded bolts or studs, in one of a plurality, preferably a plurality of pairs, i.e. at least three, of passenger seat positions in a manner that also enables adjustment of the passenger seat, e.g. pillion, to be done independently and/or separately of adjustment of the position of the operator or driver seat. In such a preferred embodiment, a fore-aft extending rear passenger seat mounting bracket is used to attach the rear of the passenger seat, e.g. pillion, to part of the motorcycle in at least a plurality, preferably at least a plurality of pairs, i.e. at least three, seat adjustment positions.

### DRAWING DESCRIPTION

One or more preferred exemplary embodiments of the invention are illustrated in the accompanying drawings in which like reference numerals represent like parts throughout and in which:

FIG. 1 is a fragmentary side elevation view of a motorcycle equipped with a driver seat of a position-adjustable motorcycle seat assembly of the present invention disposed in a first seat position;

FIG. 2 is a fragmentary side elevation view of the motorcycle of FIG. 1 with the driver seat of the position-adjustable motorcycle seat assembly disposed in a second seat position;

FIG. 3 is a fragmentary top plan view of a front portion of one preferred embodiment of a driver seat base of the position-adjustable motorcycle seat assembly constructed and arranged with a plurality of spaced apart seat position adjustment enabling mounts that enable mounting of the driver seat of the position-adjustable motorcycle seat assembly in one of a plurality of spaced-apart seat positions;

FIG. 4 is a fragmentary top plan view of the front portion of another preferred embodiment of a driver seat base of the position-adjustable motorcycle seat assembly constructed and arranged with a plurality of pairs of spaced apart seat position adjustment enabling mounts that enable mounting of the driver seat of the position-adjustable motorcycle seat assembly in one of a plurality of pairs of spaced-apart seat positions;

FIG. 5 is a fragmentary bottom plan view of a rear portion of the driver seat illustrating a position-adjustable mounting bracket used to mount the driver seat to the motorcycle attached to a rear portion of the driver seat base in a first seat position setting;

FIG. 6 is a fragmentary bottom plan view of the rear portion of the driver seat showing the position-adjustable driver seat mounting bracket attached to the rear portion of the driver seat base in a second seat position setting;

FIG. 7 is a top plan view of a passenger seat of the position-adjustable motorcycle seat assembly depicting an outwardly extending position-adjustable mounting bracket used to mount the passenger seat to the motorcycle in one of a plurality of passenger seat positions;

FIG. 8 is a bottom plan view of the passenger seat showing the position-adjustable passenger seat mounting bracket mounted to the passenger seat in a first passenger seat position setting; and

FIG. 9 is a bottom plan view of the passenger seat showing the position-adjustable passenger seat mounting bracket mounted to the passenger seat in a second passenger seat position setting.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and therefore should not be regarded as limiting.

### DETAILED DESCRIPTION

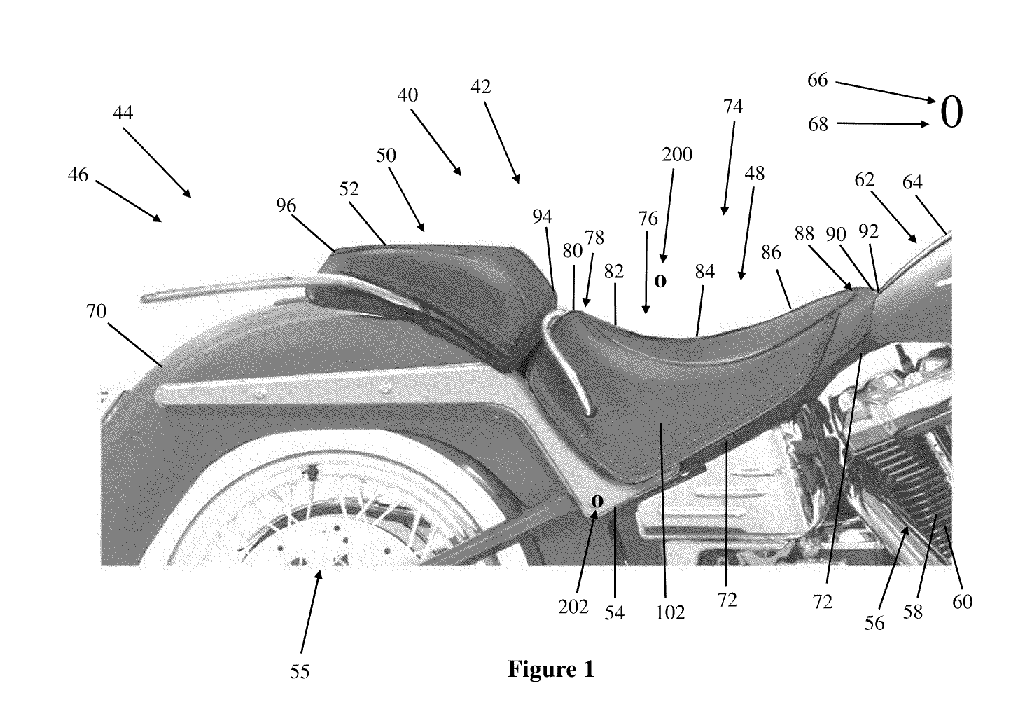

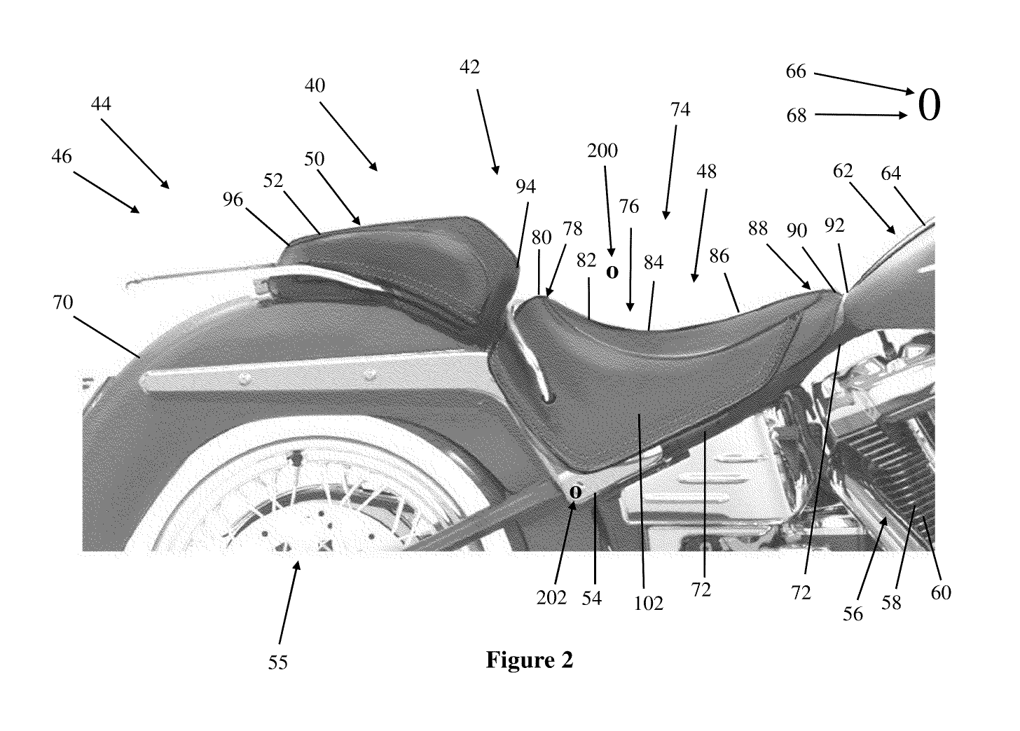

FIGS. 1 and 2 illustrate a preferred embodiment of an ergonomic position-adjustable vehicle seat assembly 40, preferably a position-adjustable motorcycle seat assembly 42, of the present invention that is configured for use with a wheeled vehicle 44, preferably a motorcycle 46, and which is constructed and arranged to enable position adjustment of at least an operator or driver seat 48 between one of at least a plurality of spaced apart driver seat positions. Where the seat assembly 40 also includes a passenger seat 50, seat assembly 40 can be and preferably is constructed and arranged to also enable position adjustment of the passenger seat 50. Where the seat assembly 40 is a position-adjustable motorcycle seat assembly 42 that also is equipped with such a passenger seat 50, e.g., rider seat 50, such as the pillion 52 shown in FIGS. 1 and 2, passenger seat 50 preferably also is position-adjustable between one of at least plurality of spaced apart passenger seat positions.

FIGS. 1 and 2 also illustrate use and operation of such a preferred position-adjustable motorcycle seat assembly 42 of the present invention with FIG. 1 showing the driver seat 48 and passenger seat 50 disposed in one seat position, a forward-most seat position, and FIG. 2 showing the driver seat 48 and passenger seat 50 disposed in another seat position rearwardly displaced from the forward-most seat position. While FIGS. 1 and 2 depict a plurality of seat adjustment positions of the position-adjustable motorcycle seat assembly 42 of the present invention, the position-adjustable motorcycle seat assembly 42 can be configured to provide at least a plurality of pairs, i.e., at least three, spaced apart seat positions. In one such preferred position-adjustable motorcycle seat assembly 42, the driver seat 48 preferably is configured for positioning in at least one of a plurality of pairs of spaced apart seat positions, i.e., at least three seat positions, with a first forward-most driver seat position as depicted in FIG. 1, a second rearwardly located driver seat position as depicted in FIG. 2 where the driver seat 48 is displaced rearwardly of the forward-most driver seat position of FIG. 1, and a third farther rearwardly located driver seat position that is not shown but which positions the driver seat 48 even farther rearwardly of the first driver seat position of FIG. 1 such that the driver seat 48 is positioned rearwardly of the second driver seat position shown in FIG. 2.

As depicted by FIGS. 1 and 2, the position-adjustable motorcycle seat assembly 42 enables position adjustment of at least the driver seat 48 in a fore-aft direction by providing at least a plurality of fore-aft spaced apart driver seat positions that enable the position of an operator or driver of the motorcycle 46 to be selectively moved closer to or farther away from the steering arrangement 66, e.g., handlebars 68, of the motorcycle 46, depending on the adjusted position of the driver seat 48. Such fore-aft driver seat position adjustability advantageously enables the position of the driver seat 48 to be adjusted in a fore-aft direction relative to the handlebars 68, such as depending on the anthropomorphic characteristics and/or comfort preference of the driver, advantageously enabling the driver seat 48 to be positioned in one position (FIG. 1) closer to the motorcycle handlebars 68 where a particular driver is smaller, shorter and/or has shorter arms or reach, while also enabling the driver seat 48 to be positioned in another position (FIG. 2) farther away from the motorcycle handlebars 68 where a particular driver is larger, taller, and/or has longer arms or reach.

In a preferred embodiment of a position-adjustable motorcycle seat assembly 42 of the present invention, the driver seat 48 preferably is not only at least position-adjustable along a fore-aft direction but also position-adjustable along a generally vertically transverse direction relative to the motorcycle 46 to which the driver seat 48 is mounted. Where the position-adjustable motorcycle seat assembly 42 also provides driver seat adjustability in a generally vertically transverse direction, adjusting or changing the position of the driver seat 48 from one position to another position not only changes the fore-aft distance of the driver seat 48 relative to the handlebars 68 but also displaces the driver seat 48 in a generally upward or vertical direction relative thereto. Such generally upward or vertical driver seat position adjustability advantageously enables the position of the driver seat 48 to be adjusted in a generally vertical or upwards direction relative to the handlebars 68, such as depending on the anthropomorphic characteristics and/or comfort preference of the driver, advantageously enabling the driver seat 48 to be positioned in either an uppermost driver seat position (FIG. 1) where the seat 48 is disposed higher and preferably highest relative to the motorcycle handlebars 68, where one driver finds such higher driver seat positioning more comfortable, or in at least one other lower seat position (FIG. 2) where the seat 48 is downwardly displaced from the uppermost position (FIG. 1) to a lower seat position relative to the handlebars 68, where another driver finds such lower driver seat positioning more comfortable.

Where equipped with a position-adjustable passenger seat 50, such as pillion 52, a preferred position-adjustable motorcycle seat assembly 42 of the present invention enables the position of the position of the driver seat 48 and passenger seat 50, e.g., pillion 52, to be adjusted substantially simultaneously together or in tandem such that adjustment of the position of the driver seat 48 also correspondingly adjusts the position of the passenger seat 50. In a preferred embodiment, the position-adjustable motorcycle seat assembly 42 can be and preferably is constructed and arranged to enable the position of the passenger seat 50, e.g., pillion 52, to be adjusted independently of the position of the driver seat 48. In one such preferred position-adjustable motorcycle seat assembly 42, position adjustment of each position-adjustable seat 48 and/or 50 preferably is independent of one another such that adjustment of the position of the passenger seat 50, e.g., pillion 52, preferably can be adjusted independently of the position of the driver seat 48 and vice versa.

As previously indicated, vehicle 44 preferably is a motorcycle 46 having an elongate longitudinally extending chassis or frame 54 carrying a plurality of fore-aft spaced apart wheels, only a rear wheel 55 of which is shown, a prime mover 56 that preferably is a motor 58, e.g., internal combustion engine 60, which drives at least one of the wheels during motorcycle operation, an energy storage unit 62 that preferably is a fuel tank 64, e.g., tear-drop shaped gasoline tank 64, for providing a source of power to prime mover 56 during motorcycle operation, a steering arrangement 66 that preferably includes handlebars 68 generically depicted in FIGS. 1 and 2 used to steer the motorcycle 46 during motorcycle operation, and at least a position-adjustable driver seat 48 of position-adjustable motorcycle seat assembly 42 in which an operator or driver sits in operating the motorcycle 46. The position-adjustable motorcycle seat assembly 42 shown in FIGS. 1 and 2 also includes a passenger seat 50 overlying a rear fender 70 above rear wheel 55 with the passenger seat 50 located rearwardly of and adjacent to the driver seat 48.

Motorcycle 46 can be of a construction like or substantially same as that shown and described in commonly owned U.S. Pat. No. 7,837,260, the entire disclosure of which is hereby expressly incorporated herein by reference, with its frame 52 having one or more portions, e.g., frame rails or tubes, extending longitudinally in a fore-aft direction, substantially the length of the motorcycle 46. Such a motorcycle frame 52 preferably includes a seat-supporting portion 72, e.g., one or more elongate frame rails or tubes, which extends longitudinally in a fore-aft direction underneath the position-adjustable motorcycle seat assembly 42 enabling each seat 48 and/or 50 of the seat assembly 42 to be carried thereby and preferably even mounted thereto. In this regard, motorcycle 46 can and preferably does have a steering arrangement 66 that includes handlebars 68 similar to or substantially the same as that shown and described in the aforementioned '260 patent that preferably include a pair of generally oppositely outwardly extending handlebar grips (not shown) which are grasped by a corresponding hand of an operator or driver (not shown) sitting in the driver seat 48 during driving operation of the motorcycle 46. Although not shown in the drawings, each one of the handlebar grips can be and preferably is equipped with one or more motorcycle controls, such as a throttle control, brake(s), gear selector control, e.g., clutch, lighting control(s), turn signal controls, and the like which can be and preferably are manipulable by a corresponding hand of a driver sitting in the driver seat 48 grasping a respective one of the handlebar grips.

The driver seat 48 of the position-adjustable motorcycle seat assembly 42 is formed of an elongate longitudinally extending saddle 74 having a generally upwardly curved concave outer seat occupant supporting surface 76 upon which rest the buttocks, tuberosity of ischium, and inner thigh portions of both legs of a rider (not shown) straddling the seat 48 when sitting in the seat 48. The seat saddle 74 has a rearwardly upwardly curved cantle 78 extending generally transversely horizontally or widthwise along a rear end 80 of the driver seat 48. The seat occupant supporting surface 76 includes a downwardly inclined seat occupant supporting surface section 82 that extends downwardly from the cantle 78 into a transitional curved central seating surface section 84 which in turn extends forwardly upwardly into an upwardly inclined surface section 86 while tapering widthwise and converging to form a generally upwardly extending pommel 88 at a front end 90 of the driver seat 48. The pommel 88 at the front end 90 of the driver seat 48 is disposed adjacent a rear end 92 of the fuel tank 64 of the motorcycle 42 and the cantle 78 at the rear end 80 of the driver seat 48 is disposed adjacent a front end 94 of the passenger seat 50. Where the position-adjustable motorcycle seat assembly 42 is also equipped with a passenger seat 50, its front end 94 preferably is disposed adjacent the rear end 80 of the driver seat 48 and extends rearwardly therefrom to a rear end 96 of the passenger seat 50 preferably defining an elongate generally oblong or oval longitudinally or fore-aft extending pillion 52.

In a preferred position-adjustable motorcycle seat assembly 42, each position-adjustable seat 48 and/or 50 of such a seat assembly 42 is substantially immovably fixed in place by being grounded to part of the motorcycle frame 54, preferably to seat-supporting portion 72, during seat position adjustment and/or when seat position adjustment is completed. As discussed in more detail below, each position-adjustable seat 48 and/or 50 of at least one preferred position-adjustable motorcycle seat assembly 42 of the present invention is configured to enable a position of each position-adjustable seat 48 and/or 50 of the seat assembly 42 to be moved from one seat position to at least one other seat position and securely retained in that position by substantially immovably fixing in place each position-adjusted seat 48 and/or 50 by grounding it to part of the frame 54.

As previously discussed, at least the driver seat 48 of the position-adjustable motorcycle seat assembly 42 is position-adjustable by being selectively movable between one preset or predetermined driver seat position, such as a first driver seat position shown in FIG. 1, and at least one other preset or predetermined driver seat position, such as a second driver seat position shown in FIG. 2, enabling a driver sitting in the driver seat 48 to be moved toward or away from the fuel tank 64 and/or handlebars 68. Such a position-adjustable motorcycle seat assembly 42 is configured so that at least the driver seat 48 is displaced in a fore-aft direction when moved from one driver seat position, such as the forward-most driver seat position shown in FIG. 1, to another driver seat position, such as the farther rearwardly disposed driver seat position shown in FIG. 2, spaced farther rearwardly therefrom. As is also depicted by FIGS. 1 and 2, a preferred embodiment of such a position-adjustable motorcycle seat assembly 42 can also be and preferably is configured to not only displace the driver seat 48 in a fore-aft direction during driver seat position adjustment, but also to displace the driver seat 48 in a generally transversely vertical direction, e.g., upwardly or downwardly, depending on driver seat position.

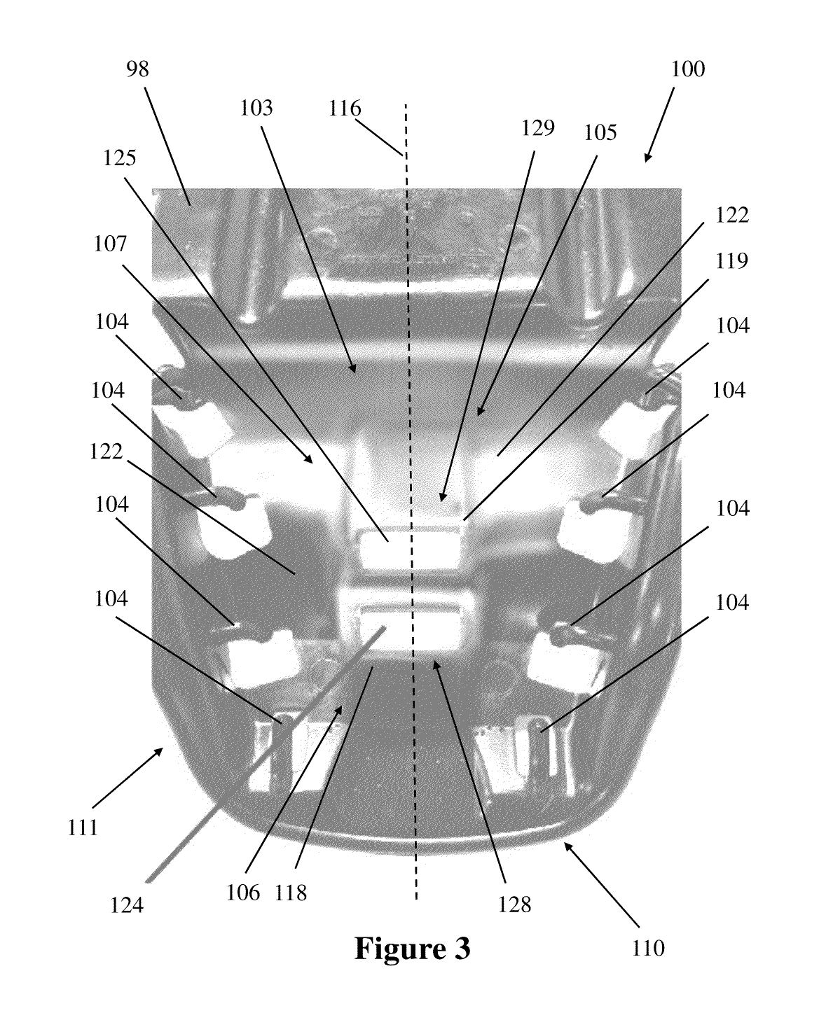

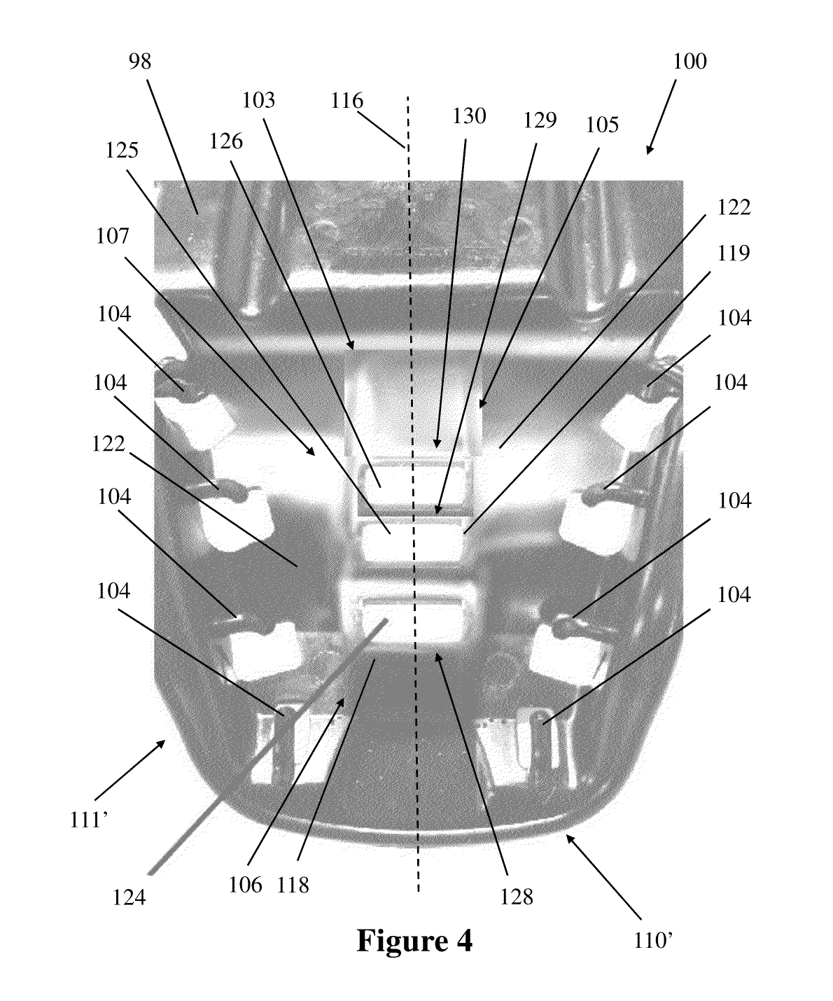

With regard to the position-adjustable driver seat 48 of the present invention, additional reference is made to FIGS. 3-6 which illustrate front and rear portions 111, 115 of an elongate fore-aft extending three dimensionally contoured and substantially rigid seat pan 98 molded of plastic or formed of metal that forms a bottom of the seat 48 and also provides a seat position adjustable base 100 for the driver seat 48. The seat base 100 underlies a deformable and resilient cushion (not shown) of the seat 48, such as a cushion made of an open or closed cell foam, which in turn is covered by a generally flexible outer seat cover 102 (FIGS. 1, 2, 5 and 6) made of leather, fabric, nylon, mesh material, woven material or another suitable seat covering material with the seat cover 102 anchored to the base 100 about the periphery of the base 100. While the seat cover 102 can be attached to the base 100 using staples, fasteners, an adhesive, or another type of seat cover attachment arrangement, the base 100 can be equipped with seat cover mounting tangs 104 integrally formed of or in the base 100 spaced about the periphery of the base 100 as depicted in FIGS. 3 and 4 which each engage a portion of the cover 102 in attaching the cover 102 to the base 100.

The driver seat base 100, e.g., seat pan 98, is elongate, generally oblong, and extends longitudinally in a fore-aft direction when mounted on the motorcycle 46 thereby generally longitudinally orienting the elongate and generally oblong driver seat 48 in a fore-aft direction relative to the motorcycle 46. As discussed in more detail below, the base 100, e.g., pan 98, is configured with an adjustable seat position mounting arrangement 103 that includes a front adjustable seat position mounting arrangement 105 with at least a plurality of front seat position adjustment enabling seat mounts 106, 107 and/or 108 disposed at or adjacent a front end 110 of the base 100 and a rear adjustable seat position mounting arrangement 109 with at least one rear seat position adjustment enabling seat mount 132a, 132b, 133a, 133b, and/or 134a, 134b disposed at or adjacent a rear end 114 of the base 100 configured to enable the driver seat 48 to be position adjustable when mounted to part of the motorcycle 46.

FIGS. 3 and 4 respectively illustrate front portions 111, 111′, e.g. front halves, of preferred embodiments of the driver seat base 100, 100′ with one preferred seat base embodiment shown in FIG. 3 having a front adjustable seat position mounting arrangement 105 that enables the driver seat 48 to be mounted to the motorcycle 46 in one of a plurality of driver seat positions, such as one of the driver seat positions shown in FIGS. 1 and 2, and another preferred seat base embodiment shown in FIG. 4 having a front adjustable seat position mounting arrangement 105′ that enables the driver seat 48 to be mounted to the motorcycle 46 in one of a plurality of pairs, i.e., at least three, driver seat positions, such as one of the driver seat positions shown in FIGS. 1 and 2 as well as in a third position farther rearwardly of the driver seat position shown in FIG. 2. If desired, a seat base 100, e.g. seat pan 98, of another preferred position-adjustable driver seat embodiment can be configured to provide even more than three fore-aft spaced apart driver seat positions.

In FIG. 3, the front adjustable seat position mounting arrangement 105 is formed of a plurality of fore-aft spaced apart seat position adjustment enabling mounts 106 and 107 that preferably are spaced apart in a fore-aft direction with the fore-aft spaced apart mounts 106 and 107 extending longitudinally along the front portion 111 of the base 100 in line with one another along a generally centrally located driver seat base centerline 116. In FIG. 4, the front adjustable seat position mounting arrangement 105′ is formed of a plurality of pairs, i.e., at least three, fore-aft spaced apart seat position adjustment enabling mounts 106, 107 and 108 that preferably are also spaced apart in a fore-aft direction with the fore-aft spaced apart mounts extending longitudinally along the front portion 111′ of the base 100′ in line with one another along a generally centrally located driver seat base centerline 116.

One or more of the mounts 106, 107 and/or 108 preferably is three dimensionally contoured or shaped, e.g. three dimensionally formed or molded, in a manner that enables or otherwise facilitates engagement with part of the motorcycle 46, preferably part of the motorcycle frame 54, more preferably part of the seat-supporting portion 72 of the frame 54, when mounting the driver seat 48 to the motorcycle 46 in one of the plurality or plurality of pairs of seat mounting positions. In a preferred driver seat base embodiment, each one of the mounts 106, 107 and/or 108 is three dimensionally contoured or shaped such as by being three dimensionally formed or molded enabling at least the mount 106, 107 or 108 associated with a desired position of the driver seat 48 being set to be able to engage with part of the motorcycle frame 54, preferably part of the seat-supporting portion 72 of the frame 54, in mounting the seat 48 in the desired position. In one such preferred driver seat base embodiment, only the mount 106, 107 or 108 corresponding to a position of the driver seat 48 desired to be set at engages with part of the seat-supporting portion 72 of the frame 54 in mounting the driver seat 48 the motorcycle 46 in the desired driver seat position.

In a preferred embodiment, at least one and preferably each one of the mounts 106, 107 and/or 108 are three dimensionally contoured or shaped, e.g., three dimensionally formed or molded defining respective fore-aft spaced apart couplers 118, 119, and/or 120 upraised from a bottom 122, e.g., generally planar bottom surface, of the base 100, 100′, e.g. seat pan, surrounding the mounts 106, 107 and/or 108. Each upraised coupler 118, 119 and/or 120 extends outwardly from the seat base bottom 122 far enough, e.g., sufficiently far, so that at least the coupler 118, 119 and/or 120 associated with the particular one of the plurality or plurality of pairs of seat position the driver seat 48 is being set during driver seat mounting engages with part of the seat-supporting portion 72 of the frame 54 in mounting the driver seat 48 in the particular desired position. In one preferred driver seat base embodiment, only the coupler 118, 119 or 120 of the mount 106, 107 or 108 corresponding to the desired seat position of the driver seat 48 engages with part of the seat-supporting portion 72 of the frame 54 in mounting the driver seat 48 the motorcycle 46 in that particular desired seat position.

In a preferred driver seat base embodiment, one of the couplers 118, 119 or 120 is upraised more than at least one of the other couplers 118, 119 or 120 to space or displace the driver seat 48 farther transversely vertically outwardly from the motorcycle handlebars 68 when the driver seat 48 is mounted to the motorcycle 46 in the seat position associated with the more upraised coupler 118, 119 or 120. In one preferred driver seat base embodiment, each one of the couplers 118, 119 or 120 is upraised by a different amount from the seat base bottom 122 such that each coupler 118, 119 and 120 transversely vertically spaces the driver seat 48 relative to the handlebars 68 a distance different than each one of the other couplers 118, 119 and/or 120. In one such preferred driver seat base embodiment, each one of the couplers 118, 119 or 120 is respectively upraised by an increasingly greater amount from the seat base bottom 122 such that each coupler 118, 119 and 120 correspondingly transversely vertically spaces the driver seat 48 relative to the handlebars 68 respectively increasing distances therefrom when the driver seat 48 is disposed in the associated seat position. In another such preferred driver seat base embodiment, each one of the couplers 118, 119 or 120 is respectively upraised by decreasingly smaller amount from the seat base bottom 122 such that each coupler 118, 119 and 120 correspondingly transversely vertically spaces the driver seat 48 relative to the handlebars 68 respectively decreasing distances therefrom when the driver seat 48 is disposed in the associated seat position.

Where it is desired to set or locate the driver seat 48 in a first or forward-most seat position like that depicted in FIG. 1, the seat 48 and/or base 100 is manipulated or maneuvered such that a first or forward-most mount 106, including its associated forward-most located coupler 118, engages with part of the seat-supporting portion 72 of the motorcycle frame 54 in mounting the driver seat 48 to the motorcycle 46 in a first or forward-most driver seat position. Where it is desired to set or locate the driver seat 48 in a second seat position located rearwardly of the first or forward-most position, such as the seat position depicted in FIG. 2 that is located rearwardly of the forward-most seat position of FIG. 1, the seat 48 and/or base 100 is manipulated or maneuvered such that a second more rearward mount, such as the mount 107 located adjacent but rearwardly of first or forward-most mount 106, including the coupler 119 of the mount 107, engages with part of the seat-supporting portion 72 of the motorcycle frame 54 in mounting the driver seat 48 to the motorcycle 46 in the second driver seat position.

Where the base 100′ of the driver seat 48 is equipped with a plurality of pairs, i.e. at least three, spaced apart mounts 106, 107 and 108 and it is desired to mount the seat 48 in a third seat position located rearwardly of both the first and second seat positions, the seat 48 and/or base 100′ is manipulated or maneuvered such that a third mount 108 located farther rearwardly of first and second mounts 106 and 107, along with its associated coupler 120, engages with part of the seat-supporting portion 72 of the motorcycle frame 54 in mounting the driver seat 48 to the motorcycle 46 in the third driver seat position. Although not shown in the drawing figures, such a third driver seat position is preferably located rearwardly of both the first driver seat position shown in FIG. 1 and the second driver seat position shown in FIG. 2.

Although not shown, one or more of the couplers 118, 119 and/or 120 can further include or be further configured with an outwardly extending portion (not shown) that projects outwardly from the seat base bottom 122 generally parallel thereto and/or inclined at an acute included angle therewith forming an outwardly projecting coupling tongue (not shown) which engages with part of the seat-supporting portion 72 of the frame 54 when the driver seat 48 is mounted to the motorcycle 46 in one of the aforementioned plurality or plurality of pairs of driver seat positions. In a preferred embodiment, at least the outwardly projecting coupling tongue (not shown) of the coupler 118, 119 and/or 120 corresponding to a desired driver seat position of the driver seat 48 engages with part of the seat-supporting portion 72 of the frame 54 when the driver seat 48 is mounted to the motorcycle 46 in the desired seat position. In one such preferred embodiment, only the outwardly projecting coupling tongue (not shown) of the coupler 118, 119 and/or 120 corresponding to a desired driver seat position of the driver seat 48 engages with part of the seat-supporting portion 72 of the frame 54 when the driver seat 48 is mounted to the motorcycle 46 in the desired seat position.

With continued reference to the driver seat base embodiments shown in FIGS. 3 and 4, one or more of the mounts 106, 107 and/or 108 includes a receptacle 124, 125 and/or 126 formed therein such that the respective coupler 118, 119 and/or 120 equipped with such a receptacle 124, 125 and/or 126 defines a coupling socket 128, 129 and/or 130 which preferably receives part of the seat-supporting portion 72 of the motorcycle frame 54 when the driver seat 48 is being mounted to the motorcycle 46 in a desired one of the plurality or plurality of pairs of driver seat positions. In the preferred embodiments of the driver seat base 100, 100′ shown in FIGS. 3 and 4, each mount 106, 107 and/or 108 preferably includes a receptacle 124, 125 and/or 126 formed in the corresponding mount 106, 107 and/or 108 such that its respective coupler 118, 119 and/or 120 defines a coupling socket 128, 129 and/or 130 which preferably receives part of the seat-supporting portion 72 of the motorcycle frame 54, preferably an outwardly projecting elongate tongue or tongue bracket (not shown), when the driver seat 48 is being mounted to the motorcycle 46 in a desired one of the plurality or plurality of pairs of driver seat positions. Although not shown, such a tongue or tongue bracket is attached to or formed of a portion of the seat-supporting portion 72 of the motorcycle frame and projects generally rearwardly and upwardly in a fore-aft direction with the tongue being slidably telescopically received in one of the coupling sockets 128, 129 and/or 130 depending upon the driver seat position desired.

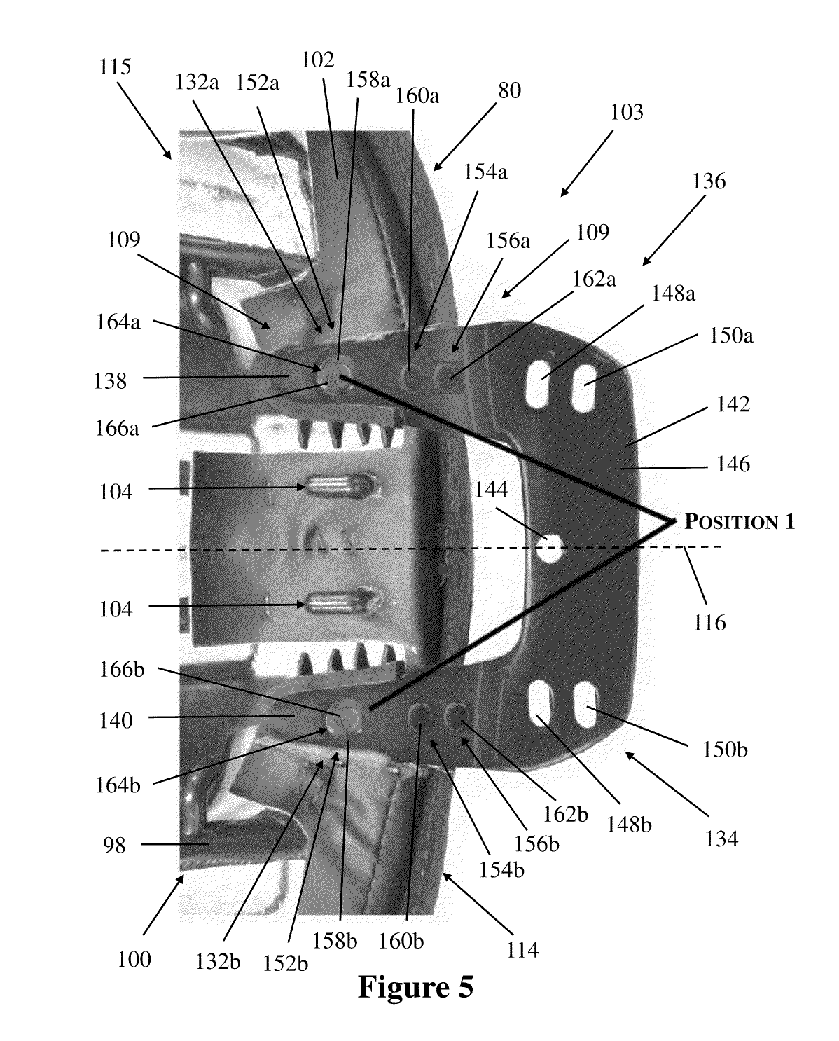

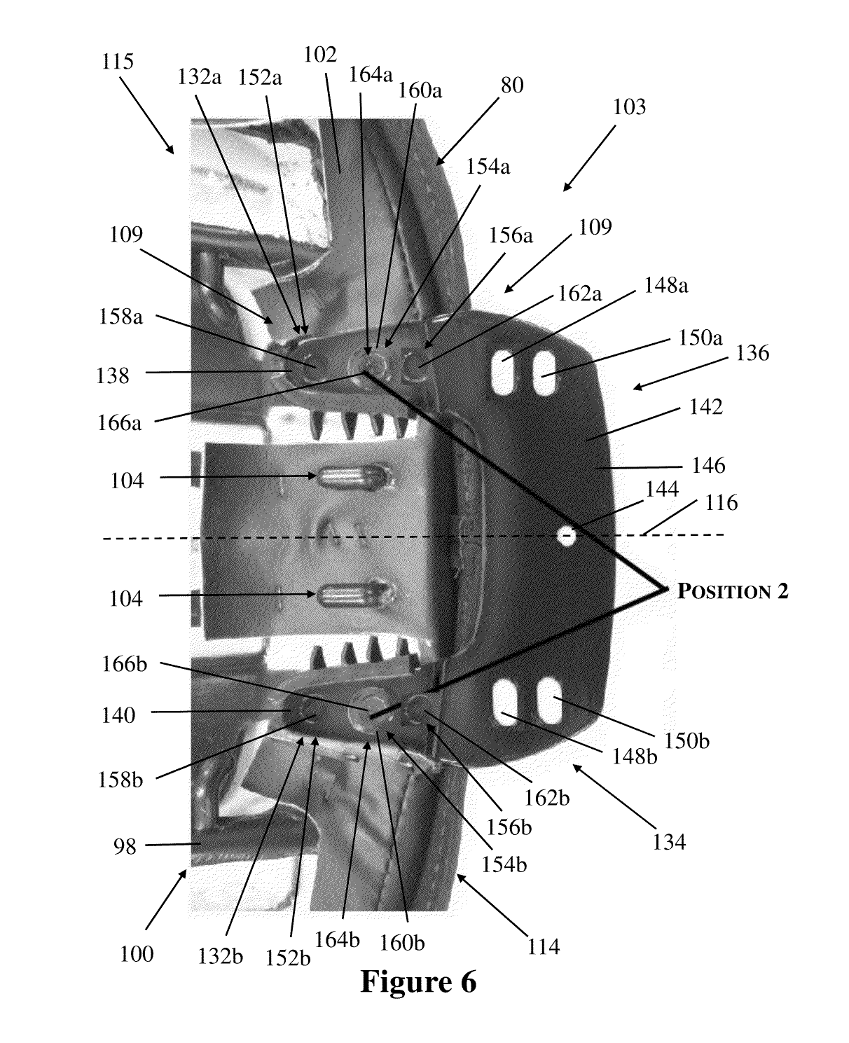

FIGS. 5 and 6 illustrate a rear portion of the driver seat position adjustable base 100, e.g. seat pan 98, along with a rear adjustable seat position mounting arrangement 109 that includes a plurality, preferably at least a plurality of pairs, i.e., at least three, of fore-aft spaced apart rear seat position adjustment enabling mounts 132a and/or 132b used to not only facilitate positioning of the driver seat 48 in one of at least a plurality, preferably at least a plurality of pairs, i.e., at least three, of fore-aft spaced apart driver seat positions but to also facilitate anchoring at least the rear portion 80 of the seat 48 to the motorcycle 46. While each one of the rear mounts 132a and/or 132b can be configured for engagement directly with part of the motorcycle 46, each one of the rear mounts 132a and/or 132b preferably is instead configured for engagement with a position adjustment enabling seat anchor 134 configured to engage part of the motorcycle 46 in mounting the seat 48 thereto in one of a plurality, preferably plurality of pairs, of driver seat positions.

In such a preferred seat base embodiment, the driver seat anchor 134 is a position adjustable seat mounting bracket 136 used to mount the rear 80 of the driver seat 48 to the motorcycle 46 when the seat 48 is disposed in the desired seat position and also forms part of the rear adjustable seat position mounting arrangement 109. The seat mounting bracket 136 preferably is horseshoe-shaped having at least one and preferably a pair of generally transversely spaced apart elongate longitudinally extending and generally parallel driver seat position adjuster arms 138 and 140 that engage the driver seat base 100 in mounting the driver seat 48 to the motorcycle 46, in one of at least a plurality, preferably at least a plurality of pairs, of driver seat positions. The driver seat position adjuster arms 138 and 140 preferably extend outwardly from a generally transversely extending seat anchoring soleplate 142 that also is part of the mounting bracket 136 and which is used to substantially immovably fix in place at least a rear portion 80 of the driver seat 48 following seat position adjustment by grounding it to part of the motorcycle 46.

While the soleplate 142 can be configured, e.g. three dimensionally configured, to directly engage part of the motorcycle 46 in anchoring at least the rear portion 80 of the driver seat 48 thereto, the soleplate 142 preferably is configured to accommodate a position-adjustable seat anchoring arrangement, which preferably includes at least one fastener (not shown), such as a threaded bolt (also not shown) or the like, which extends through a portion of the soleplate 142, preferably through a bore 144 in the soleplate 142, and engages part of the motorcycle 46 in helping to anchor at least a rear portion 115 of the driver seat base 100 thereto. In a preferred embodiment, the seat anchoring arrangement includes not just the soleplate 142, fastener, e.g. threaded bolt, but also includes bore 144 through which fastener, e.g. bolt, extends in anchoring at least the rear portion 80 of the driver seat 48 to part of the motorcycle frame 54, preferably anchoring it to part of the seat-supporting portion 72 of the frame 54. In the preferred embodiment shown in FIGS. 5 and 6, the soleplate 142 preferably has only a single generally centrally located seat fastener anchoring bore 144 enabling only a single fastener, preferably a single threaded bolt, to be used to substantially immovably fix at least the rear portion 115 of the seat base 100 to the seat-supporting portion 72 of the motorcycle frame 54 thereby grounding at least the rear portion 80 of the driver seat 48 to the motorcycle 46.

While the seat mounting bracket 136 can be configured to completely or substantially completely underlie the driver seat base 100, at least a portion of the bracket 136 preferably extends outwardly of or from the rear end 114 of the base 100 such that at least part of the soleplate 142 is disposed rearwardly outwardly therefrom to provide seat anchoring access thereto. Where the position-adjustable motorcycle seat assembly 42 includes a passenger seat 50, e.g. pillion 52, the seat mounting bracket 136, including at least the portion of the soleplate 142 that extends rearwardly of or from the base 100 and/or driver seat 48, preferably also serves as a passenger seat connector and anchoring bridge 146, e.g., pillion connector and anchoring bridge 146, to which the front portion 94 of the passenger seat 50, e.g., pillion 52, preferably is mounted.

To enable the passenger seat 50, e.g., pillion 52, to be mounted thereto, the soleplate 142 of the seat mounting bracket 136 has a plurality of sets of pairs of spaced apart elongate generally oblong oppositely outwardly extending passenger seat mounting bores 148a, 148b and 150a, 150b disposed on opposite sides of seat anchoring fastener bore 144 which each receives a corresponding fastener (not shown), preferably a threaded bolt or screw (also not shown), in attaching the front portion 94 of the passenger seat 50, e.g., pillion 52, thereto. When the driver seat position adjuster arms 138 and 140 are respectively attached to the base 100 of the driver seat 48 and the soleplate 142 attached to both the motorcycle frame 54 and the front portion 94 of the passenger seat 50, e.g., pillion 52, the rear of the driver 48 and the front of the passenger seat 50, e.g., pillion 52, are substantially immovably fixed in place to the motorcycle 46 by being grounded to the motorcycle frame 54.

To help provide driver seat position adjustability, each one of the driver seat position adjuster arms 138 and 140 of the seat mounting bracket 136 is configured to engage the driver seat base 100 in one of at least a plurality, preferably at least a plurality of pairs, of fore-aft spaced apart seat positions located or otherwise disposed at or adjacent the rear portion 115 of the base 100 to facilitate driver seat position adjustment. In this regard, FIG. 5 shows the mounting bracket 136 with its adjuster arms 138 and 140 engaged with a respective one of the rear driver seat position adjustment enabling mounts 132a and 132b in a first rear driver seat adjustment position, POSITION 1, which preferably corresponds to the first or forward-most driver seat position of the driver seat 48 shown in FIG. 1. FIG. 6 shows the mounting bracket 136 with its adjuster arms 138 and 140 engaged with a respective one of the rear driver seat position adjustment enabling mounts 132a and 132b in a second rear driver seat adjustment position, POSITION 2, spaced in a fore-aft direction from the first position, POSITION 1, with the second position, POSITION 2, preferably corresponding to driver seat position located rearwardly of the first or forward-most driver seat position of FIG. 1. In one preferred embodiment, FIG. 6 depicts the mounting bracket 136 with its adjuster arms 138 and 140 engaged with a respective one of the rear driver seat position enabling mounts 132a and 132b in the second rear driver seat adjustment position, POSITION 2, which preferably corresponds to the second rearwardly located driver seat position depicted in FIG. 1.

The driver seat position adjuster arms 138 and 140 of the generally U-shaped position adjustable seat mounting bracket 136 are each preferably configured with a plurality, preferably a plurality of pairs, of fore-aft spaced apart driver seat position adjustment settings 152a, 152b, 154a, 154b, and/or 156a, 156b one pair of which is engaged by a coupler 164a, 164b, each of which preferably is a fastener 166a, 166b, such as a threaded bolt or screw, with rear driver seat position adjustment enabling mounts 132a and 132b when the driver seat 48 is disposed in the adjustment position corresponding thereto. Each one of the driver seat position settings 152a, 152b, 154a, 154b, and/or 156a, 156b of seat mounting bracket 136 is provided by corresponding bores 158a, 158b, 160a, 160b, and/or 162a, 162b formed in a respective one of the adjuster arms 138 and 140 through which respective coupler 164a, 164b, preferably fastener 166a, 166b extends when attaching the seat mounting bracket 136 in a position corresponding to the particular position to which the driver seat 48 is set.

To enable passenger seat position adjustment, each one of the pairs of bores 148a, 148b and 150a, 150b used in mounting the passenger seat 50, e.g., pillion 52, to the soleplate 142 of the seat mounting bracket 136 are fore-aft spaced apart such that the passenger seat 50 can be mounted thereto in one of a plurality of fore-aft spaced apart passenger seat positions thereby advantageously enabling the position of the passenger seat 50 to be adjusted independently of adjustment of the position of the driver seat 48. In one preferred passenger seat embodiment, the passenger seat 50 has a plurality of transversely spaced apart threaded studs (not shown) extending outwardly from its bottom with each one of the studs inserted through a particular pair of the transversely spaced apart pairs of bores 148a, 148b or 150a, 150b, depending on the passenger seat position desired, before threading a nut or other type of fasting arrangement thereof in attaching the passenger seat 50 thereto in the desired passenger seat position. In another preferred passenger seat embodiment, a pair of bolts (not shown) are respectively inserted through a desired one of the fore-aft spaced apart pairs of transversely spaced apart bores 148a, 148b or 150a, 150b, depending upon the passenger seat position desired, before being threaded into corresponding threaded nut or the like (not shown) in the bottom of the passenger seat 50 in fixing the passenger seat 50 thereto in the desired passenger seat position. Where it is desired to provide at least three, e.g. at least a plurality of pairs, of relative passenger seat positions, the soleplate 142 of the seat mounting bracket 136 can be further configured to form one or more additional fore-aft spaced apart passenger seat positioning pairs of bores therein that are four-aft spaced apart from one of the pairs of bores 148a, 148b and/or the other one of the pairs of bores 150a, 150b.

Although not depicted in FIGS. 1 and 2, such a seat-position adjustment enabling seat mounting bracket 136 enables the passenger seat 50, e.g., pillion 52, to be moved from its position, respectively shown in FIGS. 1 and 2, relative to the driver seat 48 in a fore-aft direction to another position farther rearwardly away from the driver seat 48. Such independent position adjustability advantageously enables the position of the passenger seat 50 to be adjusted relative to the position of the driver seat 48 from a first or forward-most passenger seat position where the passenger seat 50 is disposed closest to, e.g. in abutment with, the driver seat 48, such as the first or forward-most passenger seat position shown in FIGS. 1 and 2, to at least one other passenger seat adjustment position where the passenger seat 50 is spaced farther away from the driver seat 48 then the first or forward-most passenger seat position shown in FIGS. 1 and 2.

The passenger seat 50 preferably is attached during motorcycle assembly to the soleplate 142 of the seat mounting bracket 136 using a pair of fasteners (none), preferably bolts (not shown), which extend through a respective one of the first or forward-most passenger seat positioning pair of passenger seat mounting bores 148a, 148b to at least initially position the passenger seat 50 in the first or forward-most passenger seat position where the passenger seat 50 is disposed in a first or forward-most passenger seat position where it is closest to, e.g. abuts against, the driver seat 48. Where custom ordered or subsequently desired to adjust the position of the passenger seat 50 relative to the driver seat 48 from the first or forward-most passenger seat position, the passenger seat 50 is attached to the soleplate 142 of mounting bracket 136 by inserting the fasteners, preferably bolts, through a respective one of the second or farther rearwardly spaced passenger seat positioning pair of passenger seat mounting bores 150a, 150b to locate the passenger seat 50 relative to the driver seat 48 in a second position rearwardly spaced from the first position where the passenger seat 50 is spaced from the driver seat 48 far enough to preferably form a gap or space therebetween.

Such relative position adjustability of the passenger seat 50 relative to the driver seat 48 advantageously enables the passenger seat 50 to be moved or adjusted in position relative to the driver seat 48 from the aforementioned first or forward-most passenger seat position to a second farther rearwardly spaced passenger seat position where there is a space or gap between the driver seat 48 and passenger seat 50. In a preferred embodiment, the passenger seat 50 and mounting plate 136 are configured such that moving the passenger seat 50 from its first or forward-most position to an adjacent second more rearwardly disposed position displaces or moves the passenger seat 50 relative to the driver seat 48 by a distance of at least 5 mm and preferably by a distance of at least 10 mm. In another preferred embodiment, the passenger seat 50 and mounting plate 136 are configured such that moving the passenger seat 50 from its first or forward-most position to an adjacent second more rearwardly disposed position displaces or moves the passenger seat 50 relative to the driver seat 48 by a distance of about 10 mm thereby providing relative passenger seat adjustment therebetween that advantageously accommodates passengers having a wide range of sizes, heights and the like thereby enabling a larger passenger to be spaced farther away from the driver as a result.

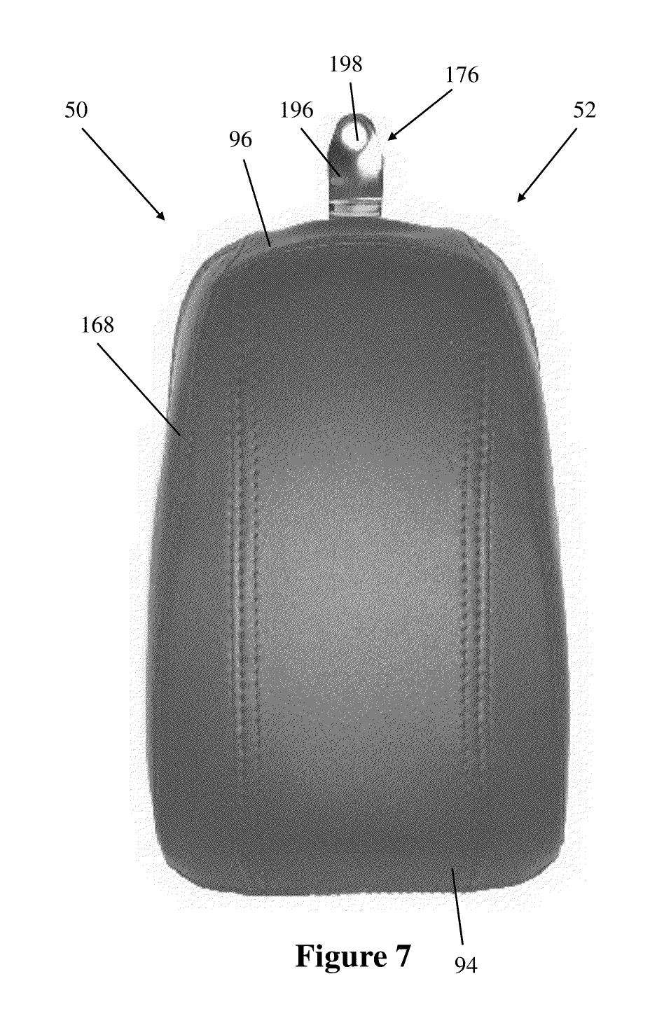

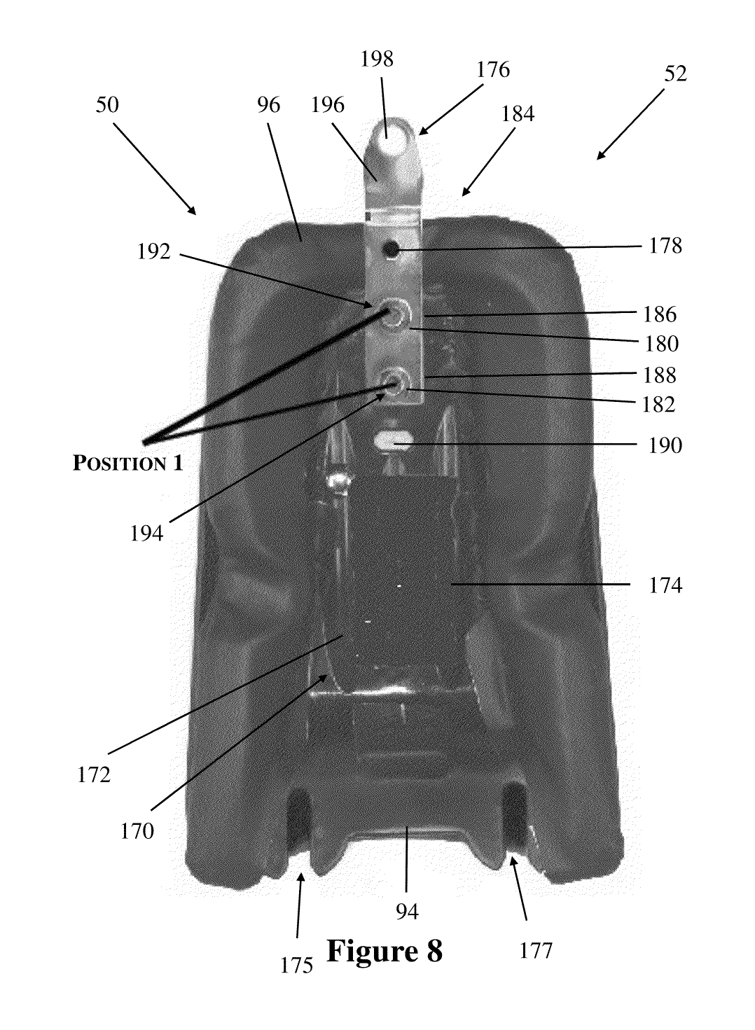

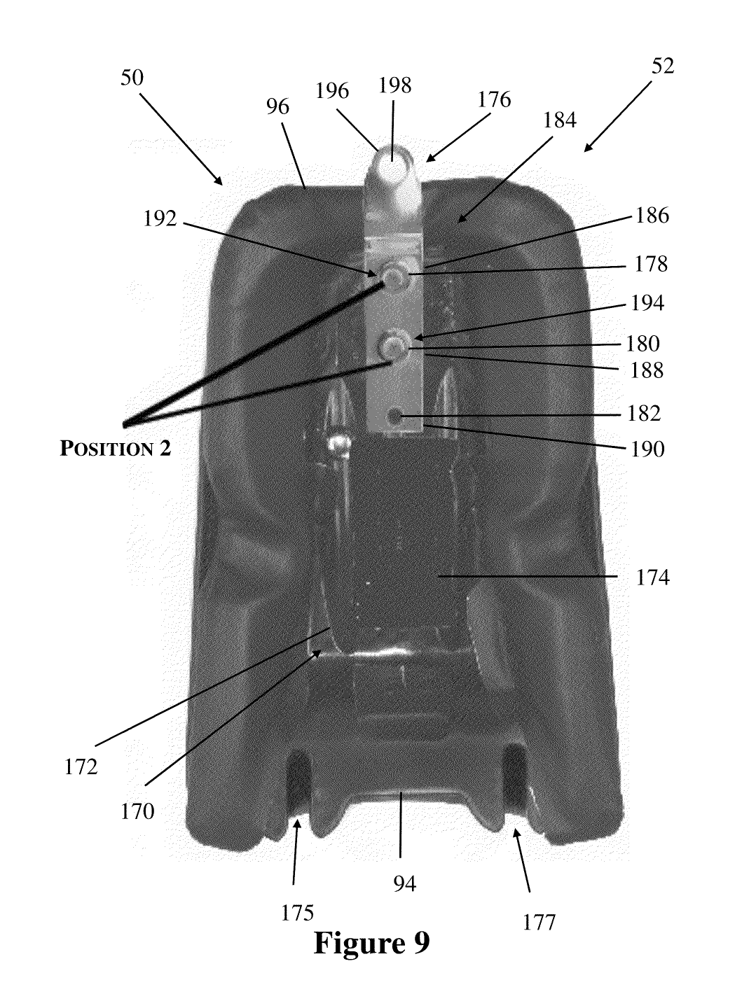

FIGS. 7-9 illustrate a preferred embodiment of a motorcycle passenger seat 50 that preferably is an elongate, generally oblong, four-aft extending pillion 52 upon which a rider or passenger of the motorcycle 46 sits positioning the rider or passenger rearwardly of the operator or driver sitting in the saddle 74 of the driver seat 48. Pillion 52 has an outer seat cover 168 overlying a base 170 forming a bottom 172 of the pillion 52 which also can be formed of a three dimensionally shaped or contoured plastic or metal seat pan 174. Depending upon the construction of the pillion 52, a cushion layer (not shown), such as a layer of open or closed cell foam, can be disposed between the outer cover 168 and the seat base 170. With specific reference to FIGS. 8 and 9, the bottom 172 of the pillion 52 can and preferably does include a pair of spaced apart and generally parallel longitudinally extending elongate slots or channels 175 and 177 formed therein which accommodate engagement with and/or attachment by fasteners, preferably bolts, which extend through a corresponding one of the pairs of passenger seat positioning pair of passenger seat mounting bores 148a, 148b or 150a, 150b in the soleplate 142 of seat mounting plate 136 depending on the particular passenger seat position that is desired. Such slots or channels 175 and 177 can also be used to receive or otherwise accommodate fender studs (not shown) of the motorcycle seat frame 54, including via engagement therewith.

To anchor the rear 96 of the pillion 52 to the motorcycle 46 in a manner that also permits seat position adjustment, an elongate generally longitudinally fore-aft extending seat-position adjustable pillion mounting bracket 176 is used that is configured to enable the position of the pillion 52 to be adjusted or moved between at least a plurality of seat positions, e.g., seat position settings, in accordance with the present invention. The pillion mounting bracket 176 has an elongate longitudinally extending mounting tongue 196 extending outwardly from the rear 96 of the pillion 52 that is configured for attachment to the motorcycle 46, preferably by being attached to part of the frame 54 of the motorcycle 46, including by being attached to the rear fender 70 of the motorcycle 46. The mounting tongue 196 of the bracket 176 preferably has a bore 198 formed therein that receives a fastener (not shown), such as a bolt, e.g. stud, used to attach the tongue 196 to the motorcycle 46.

The seat-position adjustable pillion mounting bracket 176 has at least a plurality of pairs, i.e. at least three, of fore-aft spaced apart positioners 178, 180 and 182 formed therein, a plurality of which are used in facilitating engagement and preferably attachment of the bracket 176 to the pillion base 170 in one of at least a plurality of fore-aft spaced apart seat positions or seat position settings. In a preferred embodiment, each one of the positioners 178, 180 and 182 includes or is defined by a bore formed in the bracket 176 that preferably extends completely through the bracket 176. In the preferred pillion 52 shown in FIGS. 7-9, the pillion 52 and position-adjustable mounting bracket 176 define a position-adjustable coupling arrangement 184 formed of at least a plurality, preferably at least a plurality of pairs, of fore-aft spaced apart coupling sockets 186, 188 and 190 formed in the pillion base 170, e.g., formed in the pillion bottom 172, each of which is configured, e.g., threaded, to receive and engage with one of a plurality of couplers 192 and 194, each of which preferably is a fastener, preferably a threaded bolt, used to mount the bracket 176 to the pillion 52 in one of at least a plurality, preferably at least a plurality of pairs, of fore-aft spaced apart seat position setting each preferably corresponding to one of at least a plurality, preferably at least a plurality of pairs, of fore-aft spaced apart seat positions.

FIG. 8 shows the bottom 172 of the pillion 52 with the position-adjustable pillion mounting bracket 176 attached to the seat base 170 in a first or forward-most seat position setting where the tongue 196 is farthest outwardly extended enabling positioning of both the pillion 52 and driver seat 48 in the first or forward-most seat position shown in FIG. 1. When disposed in the first or forward-most position setting, one of the couplers 192 extends through intermediate positioner 180 of bracket 176 and is threadably received in rearward-most coupling socket 186 and the other one of the couplers 194 extends through forward-most positioner 182 and is threadably received in intermediate coupling socket 188.

FIG. 9 shows the bottom 172 of the pillion 52 with the position-adjustable pillion mounting bracket 176 disposed in a second or rearward seat position setting displaced from the aforementioned first or forward-most position setting where the tongue 196 is retracted from that shown in FIG. 8 enabling positioning of both the pillion 52 and driver seat 48 in the second or farther rearward seat position shown in FIG. 2. When disposed in the second or farther rearward seat position setting, one of the couplers 192 extends through rearward-most positioner 178 of bracket 176 and received in rearward-most coupling socket 186 and the other one of the couplers 194 extends through intermediate positioner 180 and received in intermediate coupling socket 188.

In use and operation of an ergonomic position-adjustable vehicle seat assembly 40 of the present invention, adjustment of the position of the driver seat 48 from the first or forward-most driver seat position shown in FIG. 1 to the second or farther rearwardly displaced driver seat position shown in FIG. 2 displaces or moves the driver seat 48 in a fore-aft direction correspondingly displacing a seat occupant reference point 200 of the driver seat 48 in a fore-aft direction as also depicted in FIGS. 1 and 2. In addition to displacing the seat occupant reference point 200 of the driver seat 48 generally in a fore-aft direction, adjusting the position of the driver seat 48 also displaces seat occupant reference point 200 generally transversely upwardly or downwardly including relative to a fixed vehicle ground reference point 202 disposed adjacent the seat 48 that is located on the ground or frame 54 of the motorcycle 46 that remain stationary on the ground or frame 54 during seat position adjustment. In one preferred embodiment and implementation of such an ergonomic position-adjustable vehicle seat assembly 40 of the present invention, changing the position of the driver seat 48 from its first or forward-most position shown in FIG. 1 to the more rearwardly displaced second or farther rearward position shown in FIG. 2 not only displaces the seat 48 and its reference point 200 rearwardly away from the adjacent rear end 92 of the gas tank 64 and the handle bars 68 it also causes the reference point 200 to be displaced slightly lower than when the seat 48 was disposed in the first or forward-most position.

The driver seat occupant reference point 200 can either be the H-point of the driver seat 48 as determined as known in the art or can be the seat index point (SIP) of the seat 48 as determined in accordance with Society of Automotive Engineers (SAE) standard number J1163, preferably J1163_201205. In one preferred embodiment and implementation of such an ergonomic position-adjustable vehicle seat assembly 40 of the present invention, driver seat occupant reference point 200 is the H-point of the seat 48 and in another preferred embodiment of such an ergonomic position-adjustable vehicle seat assembly 40 of the present invention, driver seat occupant reference point 200 is the SIP of the seat 48 determined in accordance with Society of Automotive Engineers (SAE) standard number J1163, preferably J1163_201205.

In addition to displacement of the driver seat occupant reference point 200 in both a generally horizontal and generally vertical direction when the position of the driver seat 48 is between its first or forward-most position of FIG. 1 and its second or farther rearwardly disposed position of FIG. 2, such an ergonomic position-adjustable vehicle seat assembly 40 constructed in accordance with the present invention also correspondingly adjusts or changes an angle of inclination of the generally upwardly inclined seat saddle surface 86 of the seat occupant supporting surface by at least two degrees, preferably at least three degrees, and more preferably at least degrees from its original angle of inclination when the seat 48 was disposed in the first or forward-most position of FIG. 1.

In a preferred embodiment, the seat occupant reference point 200 moves in a fore-aft direction at least 5 mm and preferably moves at least 10 mm relative to fixed vehicle ground reference point 202 during seat position adjustment of the driver seat 48 between its first or forward-most seat position of FIG. 1 and its second or farther rearwardly located seat position of FIG. 2. In another preferred embodiment, the seat occupant reference point 200 moves in a fore-aft direction at least 15 mm and preferably moves at least 20 mm relative to fixed vehicle ground reference point 202 during seat position adjustment of the driver seat 48 between its first or forward-most seat position of FIG. 1 and its second or farther rearwardly located seat position of FIG. 2. In a further preferred embodiment, the seat occupant reference point 200 moves in a fore-aft direction at least 20 mm and preferably moves at least 25 mm relative to fixed vehicle ground reference point 202 during seat position adjustment of the driver seat 48 between its first or forward-most seat position of FIG. 1 and its second or farther rearwardly located seat position of FIG. 2. In a still further preferred embodiment, the seat occupant reference point 200 moves in a fore-aft direction between 5 mm and 40 mm at least 15 mm and more preferably between 10 mm and 30 mm relative to fixed vehicle ground reference point 202 during seat position adjustment of the driver seat 48 between its first or forward-most seat position of FIG. 1 and its second or farther rearwardly located seat position of FIG. 2.

An ergonomic position-adjustable vehicle seat assembly 40 constructed in accordance with the present invention capable of such driver seat displacement(s) between driver seat positions in changing driver seat position advantageously enables the position of the driver seat 48 to be adjusted or set between at least one of two positions, preferably between at least one of three or more positions, to a seat position that better accommodates a wider variety of operators or drivers thereby increasing their comfort during motorcycle use and operation. Such an ergonomic position-adjustable vehicle seat assembly 40 constructed in accordance with the present invention capable of providing such seat position displacement(s) when adjusted from one position to the next or adjacent position also advantageously enhances operator or driver comfort and motorcycle ergonomics improving operator or driver customer satisfaction. Finally, such an ergonomic position-adjustable vehicle seat assembly 40 constructed in accordance with the present invention capable of providing such seat position displacement(s) when adjusted from one position to the next or adjacent position also advantageously enables such enhanced comfort levels to be provided to a greater anthropometric range of riders including drivers or operators smaller than or falling outside of the 5^{th} percentile and/or drivers or operators larger than or falling outside of the 95^{th} percentile.

In addition, an ergonomic position-adjustable vehicle seat assembly 40 constructed in accordance with the present invention that also provides passenger seat or pillion adjustability also advantageously enhances passenger or rider comfort preferably in a similar manner to that of the operator or driver. Such an ergonomic position-adjustable vehicle seat assembly 40 of the present invention that is constructed and arranged as described hereinabove to allow the position of the passenger seat 50 or pillion 52 to be changed or moved relative to the driver seat 48 can and preferably does even further improve rider or passenger comfort by enabling the passenger seat 50 or pillion 52 to be displaced from a position adjacent to, adjoining or even abutting the driver seat 48 to a position spaced farther away therefrom where there is even a space of at least 5 mm, and preferably at least 10 mm, between the front 94 of the passenger seat 50 or pillion 52 and the rear 80 of the driver seat 48. Such versatile position adjustability of such constructed and arranged to provide passenger seat 50 or pillion 52 seat position adjustability independent of seat position adjustability of the driver seat 48 enables larger, heavier and/or taller passengers or riders to be better accommodated by enabling the passenger seat 50 or pillion 52 to be moved farther away from the driver seat 48 to provide the passenger or rider more space and/or legroom.

The fasteners used to adjust the position of the driver seat 48 and/or passenger seat 50, e.g., pillion 52, of such an ergonomic position-adjustable vehicle seat assembly 40 of the present invention are preferably tool less helping to produce an ergonomic fore-aft seat position adjustable seating assembly 40 that is easy for an owner or operator of the motorcycle 46 to make fore-aft seat position adjustments to one or both of the driver seat 48 and/or pillion 52. Even without use of tool less fasteners, an ergonomic fore-aft seat position adjustable seating assembly 40 constructed in accordance with the present invention advantageously enables the fore-aft position of one or both of the driver seat 48 and/or pillion 52 to be adjusted either substantially simultaneously in unison as depicted by FIGS. 1 and 2 and/or independently of one another to enable each seat 48 and/or 52 of motorcycles 46 equipped therewith to be separately and/or independently adjusted for individual rider and/or passenger preferences. Such an ergonomic fore-aft seat position adjustable seating assembly 40 constructed in accordance with the present invention also advantageously enables driver position to be adjusted in a fore aft direction relative to one of the fuel tank 64 and/or handlebars 68 for improved ergonomics and/or comfort. Such an ergonomic fore-aft seat position adjustable seating assembly 40 constructed in accordance with the present invention also advantageously enables passenger position to be adjusted in a fore aft direction relative to the position of the driver in a fore aft direction for improved ergonomics and/or comfort of the passenger.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

It is claimed:

1. A position adjustable motorcycle seat assembly comprised of a driver seat whose position on a motorcycle to which the driver seat is mounted is adjustable between one of a plurality of spaced apart driver seat positions.

2. The position adjustable motorcycle seat assembly of claim 1 wherein the driver seat is comprised of a position-adjustable driver seat mounting arrangement having a plurality of spaced apart driver seat mounts with one of the driver seat mounts engaged with the motorcycle in one of the driver seat positions when the driver seat is mounted to the motorcycle in the one of the driver seat positions and another one of the driver seat mounts engaged with the motorcycle in another one of the driver seat positions when the driver seat is mounted to the motorcycle in the another one of the driver seat positions, when mounting the driver seat in one of the driver seat positions to the motorcycle and another one of the driver seat mounts engaged with the motorcycle when mounting the driver seat in another one of the driver seat positions to the motorcycle.

3. The position adjustable motorcycle seat assembly of claim 2 wherein each one of the driver seat mounts is three dimensionally contoured for engagement with part of the motorcycle in mounting the driver seat thereto in a corresponding one of the plurality of spaced apart driver seat positions.

4. The position adjustable motorcycle seat assembly of claim 3 wherein the driver seat mounts are longitudinally spaced from one another in a fore-aft direction such that one of the driver seat positions is longitudinally spaced from another one of the driver seat positions in a fore-aft direction.

5. The position adjustable motorcycle seat assembly of claim 3 wherein the driver seat mounts are vertically transversely spaced apart from one another such that one of the driver seat positions is vertically transversely spaced apart from another one of the driver seat positions.

6. The position adjustable motorcycle seat assembly of claim 3 wherein each one of the driver seat mounts comprises a coupler that engages part of the motorcycle when mounted thereto in a corresponding one of the plurality of spaced apart driver seat positions.

7. The position adjustable motorcycle seat assembly of claim 6 wherein the driver seat mounts are longitudinally and vertically transversely spaced apart such that one of the driver seat positions is spaced from another one of the driver seat positions in both a fore-aft and generally vertical direction.

8. The position adjustable motorcycle seat assembly of claim 6 wherein the position-adjustable driver seat mounting arrangement comprises a seat base in which the coupler of each one of the driver seat mounts is formed.

9. The position adjustable motorcycle seat assembly of claim 6 wherein each one of the driver seat mounts further comprises a coupler socket that receives a portion of a frame of the motorcycle when mounted thereto in a corresponding one of the plurality of spaced apart driver seat positions.

10. The position adjustable motorcycle seat assembly of claim 9 wherein the position-adjustable driver seat mounting arrangement comprises a seat base in which the coupler socket of each one of the driver seat mounts is formed.

11. The position adjustable motorcycle seat assembly of claim 2 wherein the position-adjustable driver seat mounting arrangement further comprises a driver seat mounting bracket spaced from the plurality of spaced apart driver seat mounts, the driver seat mounting bracket mounting the driver seat to the motorcycle in one of the plurality of spaced apart driver seat positions.

12. The position adjustable motorcycle seat assembly of claim 11 wherein the driver seat mounting bracket has a plurality of spaced apart couplers with one of the couplers anchoring the driver seat to the motorcycle when the driver seat is mounted to the motorcycle in one of the plurality of driver seat positions and another one of the couplers anchoring the driver seat to the motorcycle when the driver seat is mounted to the motorcycle in another one of the driver seat positions.

13. The position adjustable motorcycle seat assembly of claim 12 wherein the couplers are longitudinally spaced from one another in a fore-aft direction.

14. The position adjustable motorcycle seat assembly of claim 12 wherein each one of the couplers comprises a fastener.

15. The position adjustable motorcycle seat assembly of claim 2 further comprising a passenger seat whose position on the motorcycle to which the passenger seat is mounted is adjustable between one of a plurality of spaced apart passenger seat positions.

16. The position adjustable motorcycle seat assembly of claim 15 wherein the driver seat and passenger seat are adjustable in unison therewith between a plurality of seat positions.

17. The position adjustable motorcycle seat assembly of claim 16 wherein the driver seat and passenger seat are connected together by a seat mounting bracket configured with a plurality of spaced apart seat-position adjustment enabling mounting positions used to mount the driver and passenger seat to the motorcycle in the one of the plurality of seat positions.

18. The position adjustable motorcycle seat assembly of claim 15 wherein the passenger seat is adjustable between a plurality of passenger seat positions independently of the driver seat.

19. The position adjustable motorcycle seat assembly of claim 1 further comprising a passenger seat whose position on the motorcycle to which the passenger seat is mounted is adjustable between one of a plurality of spaced apart passenger seat positions.

20. The position adjustable motorcycle seat assembly of claim 19 wherein the positions of the driver seat and the passenger seat are adjustable independently of one another.

21. The position adjustable motorcycle seat assembly of claim 19 wherein the driver seat and passenger seat are connected together by a seat mounting bracket configured with a plurality of spaced apart seat-position adjustment enabling mounting positions used to mount the driver and passenger seat to the motorcycle in the one of the plurality of seat positions.

22. The position adjustable motorcycle seat assembly of claim 19 wherein the driver seat and passenger seat are adjustable in unison therewith between a plurality of seat positions.

23. The position adjustable motorcycle seat assembly of claim 19 wherein the driver seat and passenger seat are connected together by a seat mounting bracket configured with a plurality of spaced apart seat-position adjustment enabling mounting positions used to mount the driver and passenger seat to the motorcycle in the one of the plurality of spaced apart seat positions.

24. The position adjustable motorcycle seat assembly of claim 1 wherein the driver seat is mounted to the motorcycle by a mounting bracket having a plurality of spaced apart driver seat mounting positions enabling the driver seat to be mounted to the mounting bracket in one of the plurality of driver seat mounting positions corresponding to a desired one of the plurality of spaced apart driver seat positions.

25. The position adjustable motorcycle seat assembly of claim 24 wherein the driver seat has a seat base with a plurality of fore-aft spaced apart seat position mounts with one of the seat position mounts corresponding to a desired one of the plurality of driver seat positions engaged with part of the motorcycle in setting the driver seat in the desired one of the plurality of driver seat positions.

26. The position adjustable motorcycle seat assembly of claim 24 further comprising a passenger seat mounted to the mounting bracket and wherein the mounting bracket is further comprised of a plurality of fore-aft spaced apart passenger seat mounting positions that enable mounting of the passenger seat thereto in one of a plurality of fore-aft spaced apart passenger seat positions.

27. The position adjustable motorcycle seat assembly of claim 26 wherein the driver seat and passenger seat are position adjustable substantially in unison therewith between a plurality of fore-aft spaced apart seat positions.

28. The position adjustable motorcycle seat assembly of claim 27 wherein the driver seat and passenger seat are position adjustable independently of one another.
